(19) United States
(12) Patent Application Publication
(10) Pub. No.: US 2011/0127718 A1
(43) Pub. Date: Jun. 2, 2011

(54) Apparatus and Method for an Illusionary Three-Dimensional Puzzle

(75) Inventors: Kirk Wescom, Machesney Park, IL (US); Gary Payne, Belvidere, IL (US)

(73) Assignee: PATCH PRODUCTS, INC., Beloit, WI (US)

(21) Appl. No.: 12/957,516

(22) Filed: Dec. 1, 2010

Related U.S. Application Data
(60) Provisional application No. 61/283,253, filed on Dec. 1, 2009.

(51) Int. Cl. A63F 9/10; B26D 3/10

(52) U.S. Cl. 273/157 R; 472/72; 83/13

(57) ABSTRACT

Disclosed herein is an apparatus that includes, a substrate having a first side and a second side, wherein the substrate is divided into a plurality of pieces, and a two-dimensional image situated on at least one of the first side and second side of the substrate, wherein each piece contains a complementary image portion, such that when the plurality of pieces having complementary image portions are positioned adjacent each other, the image is complete, and wherein the image includes a plurality of colors configured to facilitate a three-dimensional illusion.

### CROSS-REFERENCE TO RELATED APPLICATION

This application claims the benefit of and hereby incorporates herein by reference U.S. Application No. 61/283,253 entitled “Apparatus and Method for an Illusionary Three-Dimensional Puzzle,” filed Dec. 1, 2009.

### FIELD OF THE INVENTION

The present invention relates to puzzles.

### BACKGROUND OF THE INVENTION

Puzzles are conventionally known as a source of entertainment that offers a challenge to join together numerous portions of an image that have been positioned on matingly engageable pieces.

### BRIEF SUMMARY OF THE INVENTION

In at least some embodiments, the apparatus and method for an illusionary three-dimensional puzzle relates to a puzzle having a substrate with a first side and a second side, wherein the substrate is divided into a plurality of pieces, and a two-dimensional image situated on at least one of the first side and second side of the substrate, wherein each piece contains a complementary image portion, such that when the plurality of pieces having complementary image portions are positioned adjacent each other, the image is complete, and wherein the image includes a plurality of colors configured to facilitate a three-dimensional illusion.

In still additional other embodiments, the apparatus and method for an illusionary three-dimensional puzzle relates to a puzzle having a plurality of puzzle pieces, wherein each piece is configured to display an image portion of a two-dimensional image, such that when the pieces are properly positioned adjacent to each other, a complete image is formed, and wherein the image includes a series of image elements, where at least some of the image elements are colored and configured to establish the illusion of colors taking up different positions in space, and wherein the image portions are configured to be instantaneously altered.

In still yet additional other embodiments, the apparatus and method for an illusionary three-dimensional puzzle relates to a method for manufacturing a jigsaw puzzle having a two-dimensional image configured for three-dimensional viewing, the method including, situating a two-dimensional image that includes a series of colored image elements on at least one side of a substrate, and cutting the substrate into a plurality of irregular shaped pieces that each include a portion of the image, wherein the colors of the image elements are configured to convey a three-dimensional illusion when the image is viewed through a diffracting-type film.

Other embodiments, aspects, features, objectives and advantages of the apparatus and method for an illusionary three-dimensional puzzle will be understood and appreciated upon a full reading of the detailed description and the claims that follow.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings. The invention is capable of other embodiments or of being practiced or carried out in other various ways. The drawings illustrate a best mode presently contemplated for carrying out the invention. Like reference numerals are used to indicate like components. In the drawings:

FIG. 1 is a perspective view of an exemplary puzzle;

FIG. 2 a side view of the three-dimensional illusion created by viewing the puzzle of FIG. 1 through a film;

FIG. 3 is a perspective view of another exemplary puzzle; and

FIG. 4 is a perspective view of a puzzle piece of FIG. 3.

### DETAILED DESCRIPTION OF THE PREFERRED EMBODIMENT

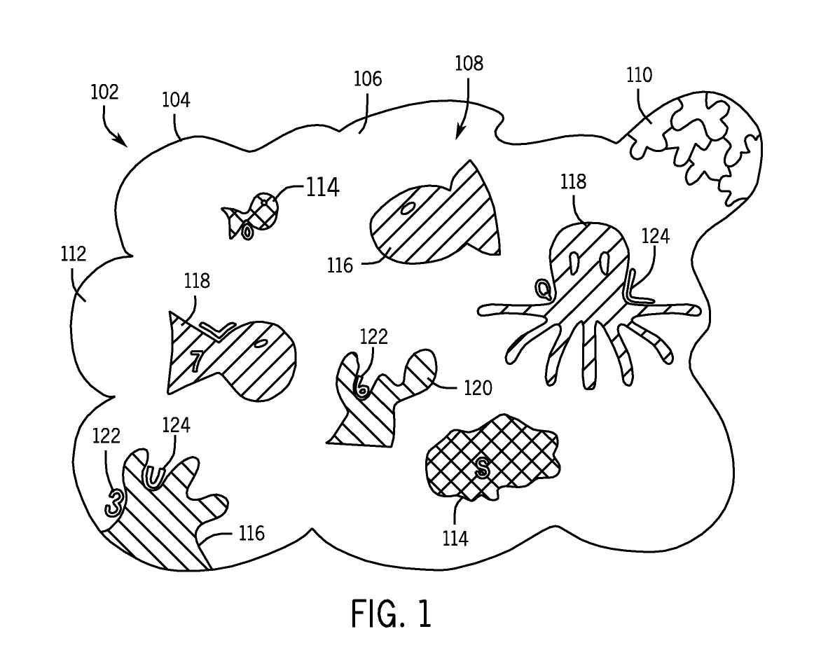

Referring to FIG. 1, an exemplary puzzle 102 is depicted comprising a substrate 104 having a top first side 106 and a bottom second side (not shown), with an image 108 situated on at least one of the sides. In the present embodiment, the substrate is cut or otherwise separated to form a plurality of pieces 110 that are configured to be fittingly coupled together. The puzzle 102 can be a jigsaw type puzzle, where the cut lines for forming each piece 110 can be varied to provide different levels of difficulty when reassembling the puzzle 102, for example and without limitation, larger pieces 110 having basic cut patterns can be formed to provide a puzzle that is easier for a young child to reassemble, whereas smaller pieces having more intricate cut patterns can be formed to increase the difficulty of reassembly for an older child or adult. Although the puzzle pieces 110 are only shown in a portion of the puzzle 102 for clarity, it is understood the puzzle can include a plurality of pieces 110 throughout. The thickness of the substrate 104 can vary, and the substrate material can be comprised of one or more of numerous materials, for example and without limitation, paper-based, wood-based, clay-coated, news-back, chipboard, grey-board, and grayback materials. In addition, the puzzle 102 can be of varied sizes, for example and without limitation, a width of about 4 inches and a length of about 6 inches, and in at least one embodiment the puzzle is configured for use on a floor and has a width of at least about 24 inches and a length of at least about 36 inches.

The image 108 is situated on the first side 106 of the substrate 104. In the present embodiment, the image 108 is printed directly on the substrate 104, although in other embodiments numerous other methods of situating the image can be used, for example and without limitation, printing the image on a second substrate (not shown) and securing the second substrate to the first substrate. In addition, a second image (not shown) can be situated on the second side of the substrate 104.

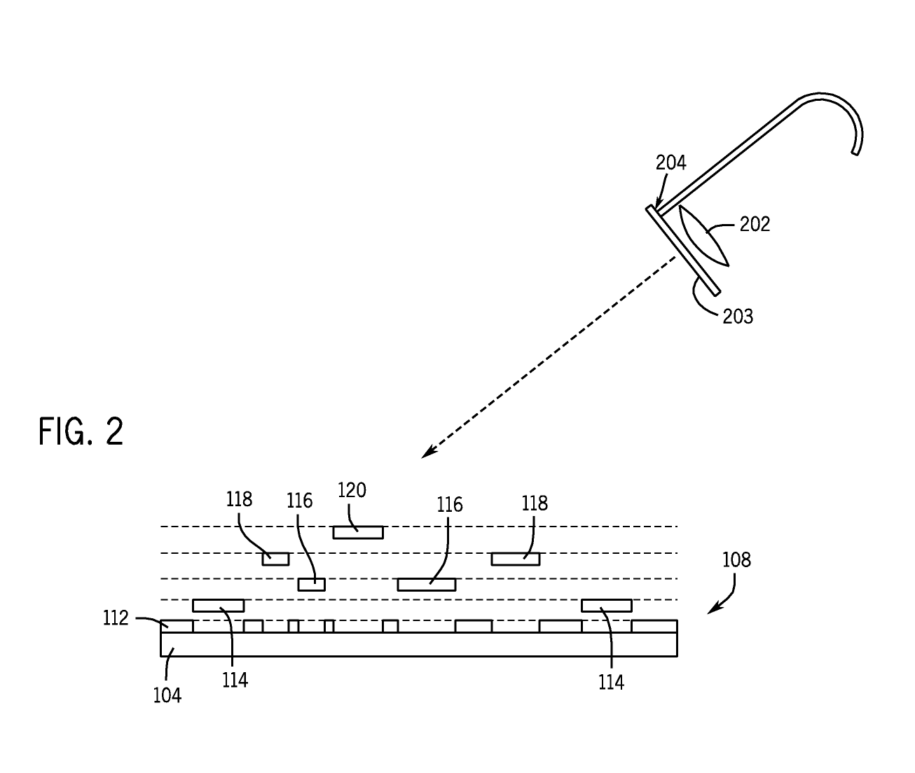

Further referring to FIG. 1, an exemplary puzzle 102 is depicted having the image 108 that includes a background section 112, and a plurality of image elements 114, 116, 118, 120, 122, 124. The background section 112 compromises the area of the image 108 that is intended to serve as the part of the image represented as being a maximum distance from a viewer (and a frontal plane, discussed below with reference to FIG. 2), with the frontal plane intended to be perceived as the closest plane to a viewer of the image 108. The image elements can include numerous objects or abstract impressions, such as animals, sea creatures, rocks, fish, insects, amphibians, reptiles, birds, musical instruments, etc. Additionally, the background 112 and image elements that form a three-dimensional illusion are colored to maximize effect as well, as discussed below. The background 112 can comprise of a typical image background found in various types of images, for example and without limitation, water, skyline, grass, etc., although the background 112 will be a single color, with any other features being image elements.

The coloring of the background 112 and image elements is controlled in part by the artistic appeal desired and in part to provide a color contrast between both the background and each of the image elements themselves so that a distinguishing effect is produced when viewed as a three-dimensional illusion. When viewed through the naked eye, a viewer will notice the color contrast in a two-dimensional manner, but when viewed through a diffracting-type film such as Chromadepth®, as manufactured by Chromatek, a three-dimensional illusion is created where the distinguishing effect becomes apparent in a three-dimensional manner. The film can serve as a pair of lenses 203 (FIG. 2) situated in a pair of glasses 204, where when worn by a viewer, the film diffracts the colors seen in the image, creating an effect that appears to shift color hues towards the center of the glasses 204 where different color hues of the visible light spectrum are shifted more than others. More particularly, red hues appear shifted more than green hues, which appear shifted more than blue hues. The farther a color is shifted by the film, the closer it appears to be situated to the viewer, thus creating a three-dimensional illusion of the image 108. Further, the shifting gradation decreases along the visible light spectrum from longer wavelength colors to shorter wavelength colors, such as from red to orange, to yellow, to green and then blue. By choosing specific color hues for an image, such as blue for a background 112 and red for an image element, the puzzle can provide the illusion of the image element being situated in the frontal plane (foreground), near the viewer.

Referring to FIG. 2, a side view of the three-dimensional illusion of the puzzle of FIG. 1 is depicted, showing the depths perceived by a viewer 202 when using film glasses 204, due to various color differentiations among the image elements. In an exemplary embodiment, the background 112 is blue in color, the image elements 114 are green, the image elements 116 are yellow, the image elements 118 are orange, and the image element 120 is red. As a result of the image color scheme, the viewer 202 perceives the image element 120 as being in the foreground, followed by image elements 118, 116, and 114, respectively, being situated increasingly towards the background 112, with the background 112 appearing situated the farthest from the viewer.

Referring again to FIG. 1, in some embodiments, included among the image elements are letters 124 and numbers 122 that are positioned about the image 108. The presence of the letters 124 and numbers 122 offers the opportunity to enhance the puzzle's entertainment and educational value by challenging a viewer 124 to find the locations of the letters 124 and numbers 122. In the present embodiment, the letters 124 include the English alphabet and the numbers 122 include the digits 1-9, although in other embodiments other letters, symbols, and numbers can be included. To further increase the entertainment and educational value, the letters 124 and numbers 122 can be camouflaged about the image 108 to increase the difficulty in locating them. The camouflage can include without limitation, warping and coloring the letters 124 and numbers 122 to conform to another adjacent object's shape and/or coloring.

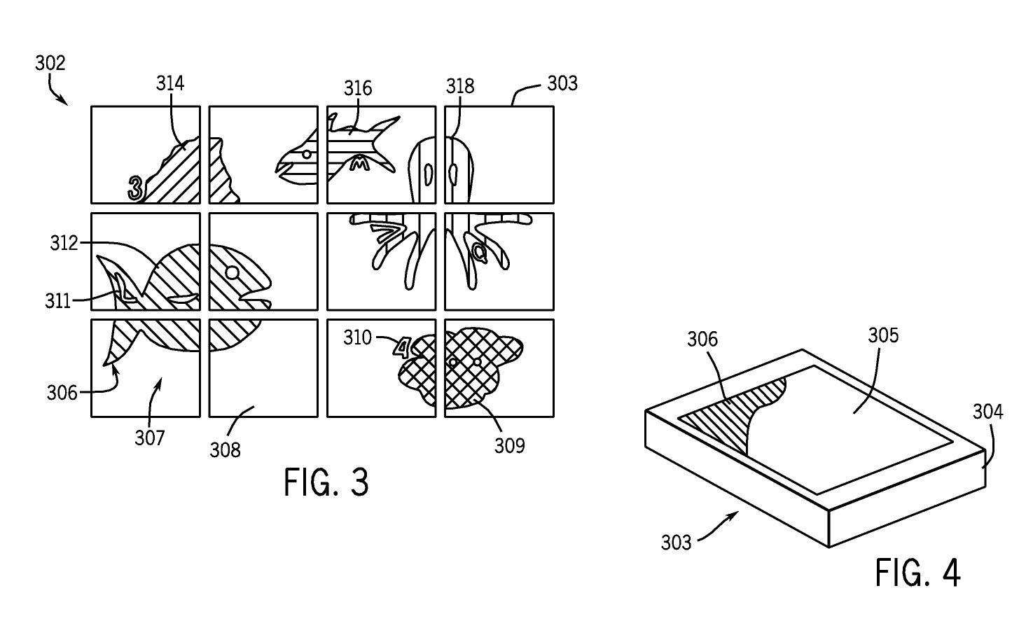

Referring now to FIG. 3, another exemplary puzzle 302 is shown having a plurality of pieces 303, with one of the pieces shown in FIG. 4. In at least one embodiment, each of the pieces includes a housing 304, a display screen 305, a computer (i.e., a processor) (not shown), and a wireless communication device (not shown). The wireless communication device is configured to communicate with other pieces and/or a central controller (not shown) using a wireless communication protocol, for example and without limitation, infra-red, Radio Frequency (RF) and Bluetooth. Using the communication devices, the pieces can be coordinated with each other to instruct their computers to form distinct image portions 306 of a complete image 307 on the display screens, where the complete image 307 is formed by situating complementary image portions 306 adjacent to each other. In at least the present embodiment, each of the communication devices further includes proximity sensing capabilities to sense when one piece is adjacent to another piece. Further, the display screen can incorporate one or more of various display technologies, for example and without limitation, light emitting diodes (LED) (e.g. OLED, OEL, LEP) and/or a liquid crystal display (LCD). As each of the pieces 303 is in communication with each other, the image portions 306 portrayed at any given time can be instantaneously changed by an orchestrated command.

In the present embodiment, the image 307 is configured to include a background 308 and a plurality of image elements 309, 312, 314, 316, and 318 that disseminate across one or more image portions 306. Similar to the aforementioned images 108, the background and image elements comprise a plurality of colors, configured to establish the illusion of the image elements being incrementally situated closer to the viewer based on their color, as discussed above. Also, as discussed above, the image elements can include letters 311 and numbers 310 wherein the letters 311 and numbers 310 can be color contrasted with the adjacent background and image elements to highlight them, or in other embodiments they can be camouflaged to blend with adjacent image elements.

It is specifically intended that the present invention not be limited to the embodiments and illustrations contained herein, but include modified forms of those embodiments including portions of the embodiments and combinations of elements of different embodiments as come within the scope of the following claims.

We claim:

1. A puzzle comprising:
a substrate having a first side and a second side, wherein the substrate is divided into a plurality of pieces; and
a two-dimensional image situated on at least one of the first side and second side of the substrate, wherein each piece contains a complementary image portion, such that when the plurality of pieces having complementary image portions are positioned adjacent each other, the image is complete;
wherein the image includes a plurality of colors configured to facilitate a three-dimensional illusion.

2. The puzzle of claim 1, wherein the image includes a plurality of colored image elements that when viewed through a light-diffracting film creates a three-dimensional illusion of the image elements.

3. The puzzle of claim 1, wherein the puzzle is a jigsaw puzzle.

4. The puzzle of claim 3, wherein the image includes a plurality of image elements, wherein at least some of the image elements are colored and situated such that the illusion of colors taking up different positions in space is conveyed to a viewer of the image when viewed through a light-diffracting film.

5. The puzzle of claim 4, wherein when viewed through the film, the image element having a color with the longest relative wavelength appears to a viewer to be positioned in space closer to the viewer at a foreground position and the image element having a color with the shortest relative wavelength appears to a viewer to be positioned in space farther from the viewer in a background position.

6. The puzzle of claim 2, wherein when viewed through the film, the order of appearance of the colored image elements from a foreground position to a background position follows the visible light spectrum from colors with the longest relative wavelength to the shortest relative wavelength.

7. The puzzle of claim 6, wherein the image elements further include a plurality of at least one of letters and numbers.

8. The puzzle of claim 7, wherein the plurality of at least one of the letters and numbers are at least partially camouflaged in the image.

9. The puzzle of claim 8, wherein the puzzle is a jigsaw puzzle.

10. The puzzle of claim 8, wherein the letters substantially constitute the complete English alphabet.

11. The puzzle of claim 8, wherein the image includes at least one of a seascape with a plurality of sea creatures and a jungle scene with a plurality of jungle animals.

12. The puzzle of claim 11, wherein the puzzle is configured for use on a floor and has a width of at least about 24 inches and a length of at least about 36 inches.

13. The puzzle of claim 12, wherein the substrate includes an image on the first and second side.

14. A puzzle comprising:
a plurality of puzzle pieces, wherein each piece is configured to display an image portion of a two-dimensional image, such that when the pieces are properly positioned adjacent to each other, a complete image is formed, and wherein the image includes a series of image elements, where at least some of the image elements are colored and configured to establish the illusion of colors taking up different positions in space, and wherein the image portions are configured to be instantaneously altered.

15. The puzzle of claim 14, wherein the illusion is conveyed to a viewer of the image when viewed through a diffracting-type film.

16. The puzzle of claim 15, wherein the order of appearance of the colored image elements from the foreground position to background position follows the visible light spectrum from colors with the longest relative wavelength to the shortest relative wavelength, when viewed through the diffracting-type film.

17. The puzzle of claim 16, wherein the plurality of pieces each include a processor with a display screen for displaying their respective image portions, and are configured for motion sensing, proximity detection, and wireless communication.

18. A method for manufacturing a jigsaw puzzle having a two-dimensional image configured for three-dimensional viewing comprising:
situating a two-dimensional image that includes a series of colored image elements on at least one side of a substrate; and
cutting the substrate into a plurality of irregular shaped pieces that each include a portion of the image;
wherein the colors of the image elements are configured to convey a three-dimensional illusion when the image is viewed through a diffracting-type film.

19. The method for manufacturing a jigsaw puzzle of claim 18, wherein the order of appearance of the colored image elements from a foreground position to a background position follows the visible light spectrum from colors with the longest relative wavelength to the shortest relative wavelength, when viewed through the film.

20. The method for manufacturing a jigsaw puzzle of claim 18, wherein the order of appearance of the colored image elements from a foreground position to a background position follows the visible light spectrum from at least red to blue, respectively, when viewed through the film.
